(19) United States
(12) Patent Application Publication
(10) Pub. No.: US 2008/0210075 A1
(43) Pub. Date: Sep. 4, 2008

(54) Longitudinal slitting machine having knife holders disposed thereon

(76) Inventors: Falk Oberhoff, Reichshaf (DE); Rudolf Supe-Dienes, Overath (DE)

Correspondence Address: ROBERT W. BECKER & ASSOCIATES, 707 HIGHWAY 333, SUITE B, TIJERAS, NM, 87059-7507, US

(21) Appl. No.: 11/940,982

(22) Filed: Nov. 15, 2007

(30) Foreign Application Priority Data
Nov. 15, 2006 (DE) 20 2006 017 387.0

(51) Int. Cl. B26D 7/26; B26D 1/24

(52) U.S. Cl. 83/482

(57) ABSTRACT

Longitudinal slitting machine having associated upper and lower knives. Knife holders for the upper knives are supported on a crosspiece. A knife head is carried by a lowering mechanism and supports an upper knife in the form of a circular knife, the lowering mechanism including a piston having a piston rod for the knife head. A path of movement of the circular knife into a cutting position is delimited by an abutment, and a depth adjuster fixes the cutting position when the knife head is lowered. A setting instrument indicates the position of cutting edges of the upper knife relative to the lower knife with reference to the true diameter of a new circular knife. The depth adjuster is positioned in conformity with a position value determined by the setting instrument. A sensor is aligned with an outer periphery of the upper knife, and during alignment of the sensor with the cutting edges of the upper knife, which alignment is effected by positioning of the depth adjuster and/or displacement of the sensor, an adjusting mechanism for a movement of the circular knife into its cutting position is fixed.

The instant application should be granted the priority date of 15 Nov. 2006, the filing date of the corresponding German patent application DE 20 2006 017 387.0.

### BACKGROUND OF THE INVENTION

The present invention relates to depth adjustment for a longitudinal slitting machine having a plurality of upper knives and lower knives that are associated with one another, whereby the blade or knife holders for the upper knives are provided with a housing that is supported on a continuous crosspiece, and a raising and lowering mechanism, disposed in the housing and actuated by pressure medium, for a knife head that is carried by the raising and lowering mechanism and supports a circular knife, whereby the raising and lowering mechanism includes a piston having a piston rod for the knife head, with the path of the circular knife into its cutting position being delimited by an abutment, and whereby a depth adjuster is provided for fixing the cutting position of the circular knife when the knife head is lowered.

DE 297 12 149 U1 discloses a longitudinal slitting machine having a knife holder for the upper knife. With this known knife holder, the raising and lowering mechanism is comprised of two parallel guide rods that are guided in a housing and on the lower free ends of which the knife head is secured, and the upper ends of which are connected to a common piston that can be supplied with a suitable medium, preferably compressed air, for carrying out the lowering movement of the knife head. With this knife holder, the depth adjuster is comprised of a threaded sleeve that is disposed between the guide rods and the position of which is adjustable by means a threaded adjustment spindle that is guided out of the lower housing. The piston is fixedly connected with an abutment element that during the lowering movement of the piston rests upon the threaded sleeve, which is a counter abutment, thereby forming a fixing of the cutting position of the circular knife in its overlap with the associated lower knife of the longitudinal slitting machine. For the reproducible setting of the piston stroke or displacement, the threaded sleeve is fixedly connected with a pointer with which is associated a scale of a vertical surface of the crosspiece.

The known design of the longitudinal slitting machine, i.e. the upper knife holder of which, has the drawback that the maintenance of a prescribed stroke or travel possible by the adjustment of the abutment for all knife holders entirely ignores the configuration of the longitudinal slitting machine as well as the conditions that occur at the circular knives that are used. For example, longitudinal slitting machines that are presently conventional have a large structural width with a corresponding longitudinal extension of their crosspiece, so that also due to the weight of the knife holders placed on the crosspiece and carried thereby, the central portion of the crosspiece can sag. Thus, those knife holders that might be disposed in a sagging portion of the crosspiece must, in order to set the same overlap depth with the lower knife, have a lesser travel than do the respectively outwardly disposed knife holders. Furthermore, over the service life of the circular knives that are used, re-sharpening can be effected several times, which results in a reduction in the diameter of the circular knife. Thus, the stroke or travel must be correspondingly increased to set the same overlap depth with the lower knife.

DE 41 30 799 A1 furthermore describes a longitudinal slitting machine that is equipped with electrically operating actuators and with which the raising and flowering mechanism operates with an electrical actuator. Disposed on the holder for the knife head is a sensor that continuously measures the distance to the upper edge of the cutting edge. If re-sharpened knives are used, the changed spacing is detected, and it is adjusted in connection with a separate control of the stroke or travel of the raising and lowering mechanism that is carried out with an electric motor.

It is an object of the present invention to embody a longitudinal slitting machine of the aforementioned general type in such a way that a depth adjustment or setting for the lowering movement of the knife head is provided in a simple to operate manner.

### BRIEF DESCRIPTION OF THE DRAWINGS

This object, and other objects and advantages of the present application, will appear more clearly from the following specification in conjunction with the accompanying schematic drawings, in which:

FIG. 1 shows a blade or knife arrangement having an upper knife, which is embodied as a circular knife, and an associated lower knife, as well as a setting instrument for the depth setting or positioning of the upper knife;

FIG. 2 shows a modified embodiment of the subject matter of FIG. 1;

FIG. 3 shows the subject matter of FIG. 1 in conjunction with a depth adjuster;

FIG. 4 shows a different embodiment of the depth adjuster of FIG. 3;

FIG. 5 is a front view of a knife holder that is to be mounted on a longitudinal slitting machine, with a different embodiment of the depth adjuster;

FIG. 6 is a side view of the knife holder of FIG. 5 showing its raising and lowering mechanism; and

FIG. 6a is a side view of the setting tool pertaining to the knife holder of FIG. 6, along with a lower knife.

### SUMMARY OF THE INVENTION

The basic concept of the present application is the provision of a setting instrument for indicating the position of the cutting edges of the upper knife relative to the lower knife with reference to the true diameter of a new circular knife, wherein the depth adjuster can be positioned in conformity with the position value determined by the setting instrument, and that a sensor is provided that is aligned with the outer periphery of the upper knife, wherein during the alignment of the sensor with the knife edges, which alignment is effected by positioning of the depth adjuster and/or displacement of the sensor, the adjusting mechanism for a movement of the circular knife into its cutting position is fixed.

The present invention has the advantage that initially, with the aid of the setting instrument, the magnitude of the required lowering movement for bringing the respectively used circular knife into its cutting position is determined, and the depth setting is then adjusted in conformity with this thus determined magnitude in such a way that with a new circular blade that hence has a true or desired diameter, the knife head respectively moves into the pertaining cutting position. Pursuant to different embodiments of the invention, either subsequently or at the same time, a sensor that is aligned with the outer diameter of the circular knife is correspondingly adjusted, so that as the knife conditions subsequently change, for example a change of the knife diameter due to a re-sharpening or subsequent remounting of a new knife having a knife diameter that is larger than that of the previously used knife, by readjusting or realigning the sensor at the same time inherently also the depth setting is adapted to the changing knife conditions. In this way it is also advantageously possible in a simple manner to change the overlap depth by adjusting the depth setting by the amount of the overlap depth that is to be changed.

Pursuant to one exemplary embodiment of the present application, the setting instrument is embodied as a setting slide that is associated with the knife head in its raised position of rest and is extendable until it rests against the lower knife, wherein a path of extension of the setting slide that covers the distance of the cutting edge of a new circular knife from the lower knife can be made visible via an indicator means. This has the advantage that the depth setting is possible without an adjusting movement of the knife head relative to the lower knife, so that the setting of the depth adjuster can be undertaken when the knife holder is not being operated and is in its position of rest. In this connection, pursuant to alternate embodiments of the invention the setting slide can be a component of a setting tool that upon set-up of the longitudinal slitting machine is to be mounted on the knife head of each knife holder supported on the crosspiece, or a setting slide can be fixedly disposed on each of the knife holders supported on the crosspiece, on which setting slide can be relied upon during the set-up of the longitudinal slitting machine.

With regard to the design of the setting slide, pursuant to different embodiments of the invention the setting slide can be a slide that is longitudinally movable relative to the knife head, or the setting slide can be embodied as a slide that can be swung out relative to the knife head, or the setting slide can be embodied as a slide that is rotatable about the knife axis.

To the extent that the depth adjuster is inventively adapted to be positioned in conformity with the position value determined by the setting instrument, pursuant to one exemplary embodiment of the invention the setting slide is provided with a measuring mark that is movable relative to a fixed scale. In this way, the value for the positioning of the depth adjuster can be read off and transferred or merged into the positioning of the depth adjuster. Instead of reading off from a scale, pursuant to another embodiment of the invention it would also be possible to convert the path of extension of the setting slide in a measuring device and to make it visible by means of a numerical indicator, so that in conformity with the numerical value made visible by the indicator the depth adjuster can also be aligned.

To the extent of that the true diameter of a new circular knife is to be utilized as the adjustment basis, pursuant to one embodiment of the invention the starting position of the setting slide can be respectively adapted or conformed to the true diameter of a new circular knife.

In this connection, initially different setting slides can be provided for the adaptation to different circular knives having different true diameters that can be used on the knife holder, with these setting slides being respectively exchangeably adapted to be fixed on the knife head. With this embodiment, it is necessary to adapt the setting slides to the dimensions of the circular knives provided for use with the longitudinal slitting machine, so that here blade holders and possibly also different setting slides must be kept available for use on different longitudinal slitting machines.

Alternatively, pursuant to another embodiment of the invention, it would also be possible to fix the setting slide to the knife head and, for the adaptation to different circular knives that can be used on the knife holder and that have different true diameters, to provide scales that are adapted to the true knife diameters. This has the advantage that the individual knife holders can have respectively identical configurations independent of the dimensions of the circular knives that are to be used on the knife holder. However, this embodiment has the problem that the distance from the lower periphery of the circular knife that is respectively to be used to the lower knife is a function of the outer diameter of the pertaining circular knife. However, to the extent that the setting slide fixed to the blade head determines the distance to the lower knife independently of the dimensions of the circular knife, an adaptation of the thus determined distance to the respective knife diameter must be undertaken, which can be effected by the use of appropriately adapted scales.

For this purpose, pursuant to exemplary embodiments of the invention the different scales can be exchangeably disposed on the knife head or displaceably disposed on the knife head is a scaling strip having different portions that contain the various scalings.

To the extent that pursuant to one embodiment of the invention the appropriate position value is made visible via a numerical indicator, with this embodiment for the adaptation of the distance or spacing to the knife size, the path of extension of the setting slide can be converted in a measuring device and can be made visible via a numerical indicator, whereby different true diameters of new circular knives are stored in the measuring device and can be supplied as a function of the circular knife that is respectively to be used.

To the extent that the depth adjuster is to be positioned in particular pursuant to the values prescribed by the setting tool, a scale can be associated with the depth adjuster for positioning it in conformity with the position value determined by the setting instrument, or alternatively, a measuring device can be associated with the depth adjuster for indicating in a numerical indicator.

The depth adjuster can itself, pursuant to various embodiments of the invention, have different configurations. For example, pursuant to a first exemplary embodiment of the invention, for the configuration of the depth adjuster, the housing of the knife holder can, accompanied by the interposition of an adjustment device, be supported on the crosspiece in such a way that the knife holder can be brought into various positions relative to the crosspiece, and whereby the sensor is disposed on the crosspiece. This embodiment has the advantage that the knife holder can be configured with a fixed stroke or travel of its raising and lowering mechanism. To the extent that the knife holder is to be adjusted in conformity with its position on the crosspiece of the longitudinal slitting machine, or also due to a change of the knife conditions relative to the lower knife, this is effected via the displacement of the entire knife holder relative to the crosspiece by means of the inter posed adjustment device. In conformity therewith, the sensor can be disposed on the crosspiece, so that in the case of a readjustment, the entire knife holder can be displaced relative to the fixed or stationary sensor until the cutting edge is aligned with the sensor.

Pursuant to an alternative embodiment of the invention, for the configuration of the depth adjuster the cylinder of the raising and lowering mechanism provided for accommodating the piston having the lowering piston rod is displaceably disposed in the housing of the knife holder, and whereby the sensor is disposed on the housing of the knife holder. Also with this embodiment the stroke or travel of the raising and lowering mechanism of the knife holder is unaltered. Rather, in the housing of the knife holder, the raising and lowering mechanism, i.e. the cylinder thereof that accommodates the piston and its piston rod, is displaced relative to the housing, so that comparable movement conditions occur as with a knife holder that is adjustable relative to the crosspiece. To this extent, with this embodiment the sensor is disposed on the housing of the knife holder, so that the cylinder of the raising and lowering mechanism shifts relative to the sensor.

Pursuant to a further embodiment of the invention, for the configuration of the depth adjuster an abutment for the movement of a counter abutment connected to the lowering piston rod into the cutting position of the circular knife is adjustably disposed, and the sensor is displaceable relative to the housing of the knife holder and is coupled with the adjustable abutment for the counter abutment in such a way that a displacement of the sensor brings about a displacement of the abutment with a displacement path for the abutment that corresponds to the displacement path of the sensor. With this embodiment, a change of the travel or stroke of the raising and lowering mechanism is now effected in that the abutment for the movement of the counter abutment is displaced during the adjustment or readjustment. This embodiment has the advantage that a direct coupling results between the sensor and the abutment. With this embodiment, with regard to the direct coupling between counter abutment and abutment, a support rod that carries the sensor can be displaceably disposed on the housing of the knife holder and is held by spring bias in abutment against the displaceable abutment; alternatively, the support rod that is displaceably disposed on the housing of the knife holder can be fixedly connected with the displaceable abutment.

To the extent that initially the amount of the lowering movement of the raising and lowering mechanism must be preset on the depth adjuster in conformity with the spacing that is determined, the sensor must also be adjusted to a zero position in conformity with a respectively circular knife. In order to carry this out, the sensor can be displaceably disposed on the support rod and can be fixed in various positions thereon. During the initial adjustment of the sensor, the sensor can thus be aligned with the outer diameter of the circular knife used during the adjustment process, so that upon subsequent alteration of the knife characteristics the readjustment of the depth adjuster is effected by means of the then-effected readjustment of the sensor, including a movement of the support rod. For this purpose, pursuant to an alternative embodiment the support rod can be embodied as a telescopic rod that also enables a relative movement of the sensor along the axis of the support rod.

Pursuant to a further embodiment of the invention, the setting instrument can be embodied as a setting tool that can be mounted on each knife head of the knife holder supported on the crosspiece and that has a dimension that corresponds to the true diameter of a new circular knife; the setting tool, together with the knife head, is to be brought into the lowered cutting position of the circular knife. In this connection, on that side that faces the lower knife, the setting tool has a step that is provided with a leg that rests upon the cutting edge of the lower knife and is provided with a leg that projects beyond the cutting edge of the lower knife with a prescribed overlap depth, whereby the distance between the end of the leg that forms the overlap depth and the upper edge of the setting tool corresponds to the diameter of a circular knife that is to be used as an upper knife, so that the adjustment or positioning of the depth adjuster can be effected by means of the value that is to be read from the scale.

Pursuant to a particular embodiment of the invention, the leg of the setting tool that forms the overlap depth can have a material thickness that is suitable for the adjusting setting of the lateral adjustment path of the upper knife relative to the lower knife. With this embodiment, by means of the setting tool respectively disposed on the knife head of the individual knife holder, the position of the sensor is aligned with the dimensions of an adopted circular knife, including its desired overlap depth with the lower knife.

In this connection, pursuant to one embodiment of the invention the lower knife can be embodied as a grooved knife, and the leg of the setting tool that forms the overlap depth respectively extends into the groove that forms the cutting edge of the lower knife.

Pursuant to an expedient embodiment of the invention, the displacement path between the raised rest position of the knife head, and the position of the setting tool moved into the abutment position upon the lower knife, can be made visible by means of an indicator or gauge.

Further specific details of the present invention will be described in detail subsequently.

### DESCRIPTION OF SPECIFIC EMBODIMENTS

Referring now to the drawings in detail, longitudinal slitting machines of the aforementioned general type, as well as the associated knife holders, are described in the aforementioned publications DE 297 12 149 U1 and DE 41 30 799 A1, so that the basic construction of a longitudinal slitting machine, and corresponding knife holders, is known and it is therefore not necessary to describe them in further detail in the following description of the present invention. To this extent, the disclosures of DE 297 12 149 U1 and DE 41 30 799 A1 are hereby incorporated into this document by this reference thereto.

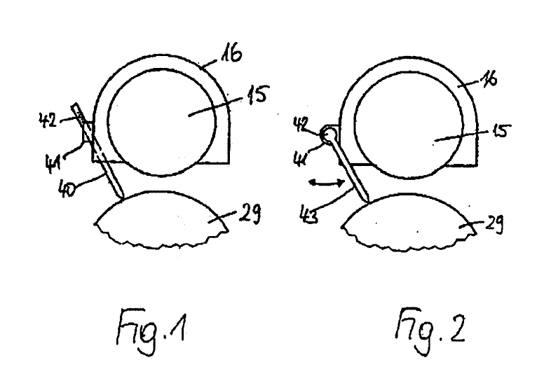

FIGS. 1 and 2 initially illustrate exemplary embodiments merely for the arrangement of a positioning or setting instrument, to be used for the adjustment of the depth adjuster, on a not further illustrated knife holder. To the extent that FIGS. 1 and 2 respectively show an upper blade or knife, embodied as circular knife 13, and an associated lower blade or knife 29, a positioning or setting slide 40, as a setting instrument, is disposed, for example, on a hand guard 16 that extends about the circular knife 13; in the raised rest position of the circular knife 13, the spacing from the lower knife 29 can be determined by the setting slide 40.

With the embodiment illustrated in FIG. 1, the setting slide 40 is embodied as a slide that is longitudinally displaceable in a slide housing 41, and that is displaceable in the slide housing 41 until it abuts against the outer periphery of the circular knife 13. On that end that extends beyond the slide housing 41 the slide 40 is provided with a scale 42, by means of which the amount of the displacement movement of the slide 40 covered relative to the slide housing 41 is made visible. Similarly, with the alternative embodiment illustrated in FIG. 2 the setting instrument is embodied as a rotary slide 43, whereby the rotary slide 43, which is rotatable in a slide housing 41 that is secured to the hand guard 16, is rotated until its front tip abuts against the outer periphery of the circular knife 13. The amount of the rotational movement is a parameter for the distance or spacing that exists between the upper knife 13 and the lower knife 29, and that is to be swept over by the lowering movement of the upper knife 13 relative to the lower knife 29, whereby this distance or spacing can be read from a scale 42 disposed on the slide housing 41.

The distance determined via the setting instrument 40, 43 between the outer periphery of the circular knife 13 facing the lower knife, and the lower knife 29, is initially used for the adjustment of the depth setting such that by means of the depth adjuster, the abutment for the lowering movement of the circular knife 13 into its cutting position is fixed in such a way that for a newly attached circular knife, the knife head is respectively moved into the cutting position in which the circular knife 13 cooperates with the lower knife 29 with the desired overlapping depth. It is to be understood that the scale 42 that is respectively used is dictated by the theoretical or true diameter of a circular knife 13 that is to be used, and therefore appropriately differing scales can, for example, be used on the setting instrument 40, 43 or the slide housing 41.

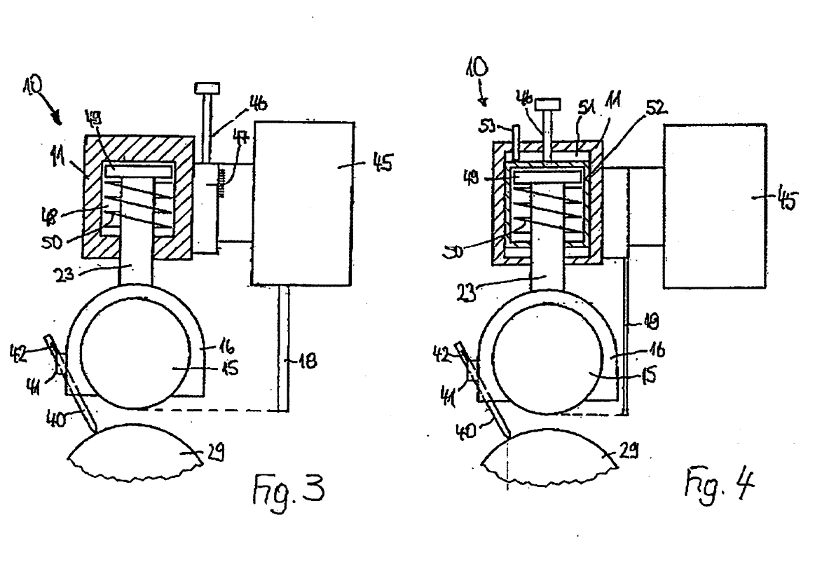

With regard to the depth adjuster, pursuant to the embodiment illustrated in FIG. 3 the entire blade or knife holder 10, together with its housing 11, is supported on a crosspiece 45 of a not further illustrated slitting machine, accompanied by the interposition of an adjustment device 46, and can thereby be brought into various positions relative to the crosspiece 45. A scale 47, which corresponds to the scale 42 associated with the setting instrument 40, 43, is disposed on the crosspiece 45, so that the knife holder 10 can be positioned via the adjustment device 46 in a height or vertical position in which the lowering mechanism, which is disposed in the knife holder 10 with a fixed, non-adjustable displacement, moves the circular knife 13 into the desired cutting position.

The circular knife 13 with the hand guard 16 forms a component of a knife head 12 that is carried by a raising and lowering piston rod 23. The piston rod 23 extends into a cylinder chamber 48 that is formed in the housing 11 of the knife holder 10; a piston 49 that is connected to the piston rod 23 is displaceable in the cylinder chamber 48. During its lowering movement, the piston 49 operates downwardly in the direction of the lower knife 29 against a spring 50, so that when the cutting process is concluded, the spring 50 provides for a return of the piston 49, along with the piston rod 23, into the position of rest of the circular knife 13. With this embodiment, the piston rod 23 along with the piston 49 has a fixed, unchangeable displacement in the housing 11 of the knife holder 10.

In order, upon later changes of the diameter of the circular knife 13, for example a reduction of the diameter due to re-sharpening, to be able to reset the lowering movement, disposed on the crosspiece 45 is a sensor 18 that in a second adjustment step is lined-up to the outer periphery of the circular knife 13. If the outer diameter of the circular knife changes, then by means of the adjustment device 46 the knife holder 10, with the circular knife 13, is displaced relative to the crosspiece 45 until the outer periphery of the circular knife 13, the diameter of which has changed, is again detected by the sensor 18. Thus, if the diameter of the circular knife 13 is reduced due to a re-sharpening, then with a fixed stroke or displacement of the lowering mechanism the knife holder 10 must be set lower so that the end setting or positioning of the circular knife 13 in the cutting position can be achieved with an unaltered overlap.

As not illustrated further, the respective true position of the circular knife 13 relative to the sensor 18 can be represented by appropriate light signals, whereby a, for example green, light signal is then given off when the position of the sensor 18 coincides exactly with the position of the outer periphery of the cutting or knife edges of the circular knife 13. In addition, if desired, it would also be possible by appropriate arrows to provide an indication in which direction the resetting of the knife holder has to be effected.

FIG. 4 illustrated an embodiment of the invention where the raising and lowering mechanism that is disposed in the housing 11 of the knife holder 10 is adjustable as such relative to the housing 11. For this purpose, the housing 11 of the knife holder 10 is provided with a receiving chamber 51 or a cylinder 52 of the raising and lowering mechanism. The cylinder 52 is displaceably disposed in the receiving chamber 51 of the housing 11 by means of an adjustment device 46, whereby the position of the cylinder 52 within the receiving chamber 51 is recognizable by a gauge 53. With this embodiment, the sensor 18 is secured to the housing 11, thus resulting in an adjustment of the knife head 12 with the hand guard 16 and circular knife 13 relative to the sensor 18. In other respects, the function of this embodiment is the same as that described in connection with the embodiment of FIG. 3.

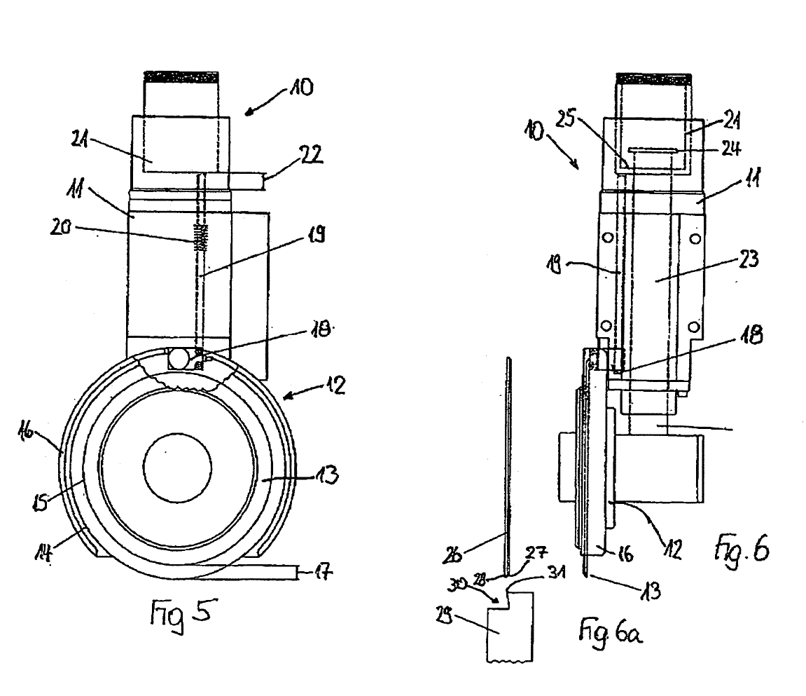

FIGS. 5 and 6 illustrate a further embodiment of the invention, according to which, in contrast to the embodiments of FIGS. 3 and 4, the stroke or displacement of the raising and lowering mechanism can 15 now be altered. At the same time, the position of the appropriately provided sensor can also be adjusted, whereby by means of the resetting of the position of the sensor required when the cutting or knife conditions change, at the same time the required adaptation of the depth setting for the knife movement is carried out.

The knife holder 10 shown in FIGS. 5 and 6 has a housing 11 in which is disposed a raising and lowering mechanism that will be described in detail subsequently and that carries a knife head 12 on which is supported a circular knife 13. To facilitate understanding of the subsequently described invention, the reference numeral 14 designates the position of the cutting edge of a new circular knife 13, while the reference numeral 15 indicates a position of the cutting edge of a re-sharpened knife, so that a difference 17 results in the position of the cutting edges 14 and 15 within which, during the length of operation of the knife holder 10, the exact position of the cutting edges travel during the cutting process. The circular knife 13 is surrounded in a customary manner by a hand guard 16 for safety reasons.

Displaceably mounted on the housing 11 of the knife holder 10 is a support rod 19, which at its lower end carries a sensor 18 by means of which the exact position of the outer periphery of the cutting edges 14, 15 of the circular knife 13 respectively mounted on the knife head 12 can be detected. For this purpose, the sensor 18 can be equipped with appropriate light signals, for example in a green/red representation, whereby a green light signal is given off if the position of the sensor coincides exactly with the position of the upper edge of the cutting edge of the circular knife 13. The support rod 19, by means of an only schematically illustrated spring 20, is held in abutment against an engagement housing 21, which is adjustably disposed in the housing 11 of the knife holder 10, in such a way that a displacement of the engagement housing 21 in the housing 11 of the knife holder 10 brings about a change of the position of the sensor 18. In the illustrated embodiment, the engagement housing 21 is embodied as a knurled-head threaded body which can be manually brought into different positions by an appropriate threading movement in the housing 11 of the knife holder 10. In this connection, schematically illustrated in FIG. 5 is the position of the engagement housing 21 that corresponds to the use of a cutting knife 13 having a new knife and consequently a position of the cutting edge 14. The reference numeral 22 indicates the possible displacement path of the engagement housing 21 in the housing 11 that corresponds to the amount of the position difference 17 between the cutting edges 14 and 15. To this extent, the position of the engagement housing 21 in the housing 11 of the knife holder 10 is set in conformity with the position difference 17 between the cutting edges 14 and 15.

As shown in detail in FIG. 6, the raising and lowering mechanism is comprised of a piston rod 23 that is guided in the housing 11 of the knife holder 10 and carries a knife head 12 at its lower end. At its upper end, the piston rod 23 is provided with an only schematically indicated counter abutment 24, which is disposed in the interior of the engagement housing 21 and is movable therein, whereby the base of the engagement housing 21 forms the abutment 25 for the adjustment movement of the counter abutment 24 having the piston rod 23. The piston itself is not recognizable in the drawing used for illustrating the invention, whereby an appropriate arrangement of piston and raising and lowering piston rod is known, for example, from the previously mentioned state of the art. In FIG. 6, the rest position of the raising and lowering mechanism, with the knife head 12 raised, is illustrated.

If, to achieve the cutting position of the circular knife 13, the raising and lowering mechanism is acted upon, preferably with compressed air, then due to the movement of the raising and lowering piston rod 23, the counter abutment 24 disposed thereon moves in the direction of the abutment 25 on the engagement housing 21. The illustrated position of the engagement housing 21, as illustrated in FIG. 5, hereby corresponds to the operation of a circular knife 13 having a position of the cutting edge 14 of a new knife. If a regrinding or re-sharpening of the knife that has been effected in the meantime is to be taken into consideration, during which the diameter of the reground circular knife has been reduced, then the displacement of the piston rod 23 having the counter abutment 24 must be altered, in other words increased, in conformity with the amount of the regrinding. For this purpose, by turning the engagement housing 21 into the housing 11 of the knife holder 10, the support rod 19 having the sensor 18 is shifted downwardly until the sensor 18 detects the altered position of the cutting edge. The engagement housing 21 then remains in this position, whereby the displacement path of the engagement housing 21, in other words the abutment 25, corresponds to the change of the diameter of the circular knife 13 due to the regrinding. To this extent, the path of the counter abutment 24 is increased by this amount until, during the lowering movement, the counter abutment encounters the abutment 25.

As has already been indicated, an optical indicator can be associated with the sensor 18 that gives off an appropriate light signal at least when the position of the sensor coincides exactly with the position of the cutting edge of the circular knife 13. In addition, an indication of direction, for example in the form of arrows that light up, can also be provided in order to give operating personnel an indication of the direction of the required resetting of the engagement housing 21.

If prior to putting the longitudinal slitting machine into operation, a one time adjustment of the sensor 18 to a zero-position must be undertaken for each individual knife holder 10, for this purpose a setting tool 26 is provided that with the embodiment illustrated in FIG. 6a is in the form of a disk-like body having a dimension corresponding to the diameter of a new circular knife. On its outer periphery, the setting tool 26 is provided with a step having a horizontal leg 27, in other words a leg resting upon the cutting edge of a lower knife, and a leg 28, which is oriented parallel to the circular knife and thereby simulates the overlap with a lower knife. For clarification, a portion of a lower knife 29 embodied as a grooved knife is illustrated, whereby the grooves 30 cut into the knife respectively form the cutting edges 31 of the lower knife 29. In this connection, the dimension of the leg 28 of the setting tool 26 is configured such that the length of the leg 28 corresponds to a normal overlap depth between upper knife and lower knife. For the adjustment of the zero-position of the sensor 18, the setting tool 26 is thus placed on the knife head 12 and the knife head is subsequently moved into its lowered cutting position. In so doing, the knife holder for the upper knife 13 is to be oriented relative to the lower knife 29 in such a way that the step of the setting tool 26 formed by the legs 27, 28 exactly picks up or covers the cutting edge 31 of the lower knife 29. If thus to this extent, with the aid of the setting tool 26, the cutting position of the raising and lowering mechanism of the knife holder 10 is simulated, then by rotating the engagement housing 21 the position of the sensor 18 is aligned with the upper edge of the setting tool 26.

When this setting process, which has to be carried out only once during the course of placing the machine into operation, is concluded, then in the manner described, by displacing the sensor 18 into its position in which it detects the upper periphery or edge of the cutting edge 14 or 15 of the respectively used circular knife 13, the abutment 25 for the counter abutment 24 of the raising and lowering mechanism is subsequently respectively displaced, whereby the overlap depth of the circular knife 13 with the cutting edge 31 of the lower knife 25, which overlap depth is prescribed by the setting tool 26, is respectively maintained. Also for the situation where this one-time adjusted or lined-up overlap depth is to be altered, it is merely necessary to displace the sensor 18 by the amount of the alteration of the overlap depth. For this purpose, an appropriate scale can be provided on the housing of the knife holder.

It is evident that it is essentially not a matter of a true dimensioning of the setting tool 26 with respect to the matching of a new knife 13 since all deviations of the position of the cutting edge of a later used circular knife in comparison to the position of the zero setting of the sensor 18 lined-up with the setting tool 26 are to be taken into consideration with each post adjustment process as a function of the concrete knife dimensions.

As not further illustrated, the setting tool can also be utilized for an adjustment of the lateral adjusting movement of the circular knife 13 against the cutting edge 31 of the lower knife 29 by providing the leg 28 that enters the groove 30 of the lower knife 29 with a defined, great material thickness. Thus, if during the lining-up process the cutting position of the knife head 12 is simulated, the lateral adjustment of the later used circular knife 13 can be set in conformity with the thickness of the leg 28 of the setting tool 26 in order to respectively prescribe a lateral adjustment that remains the same with all knife holders that are to be provided.

The subject matter of this document disclosed in the preceding specification, the claims and the drawings can be important individually as well as in any desired combination with one another for realizing the various embodiments of the invention.

The specification incorporates by reference the disclosure of German priority document DE 20 2006 017 387.0 filed 15 Nov. 2006.

The present invention is, of course, in no way restricted to the specific disclosure of the specification and drawings, but also encompasses any modifications within the scope of the appended claims.

What is claimed is:

1. A longitudinal slitting machine having a plurality of upper knives and lower knives that are associated with one another, comprising:
knife holders for said upper knives, wherein said knife holders are provided with a housing that is supported on a crosspiece;
a respective pneumatically or hydraulically operated raising and lowering mechanism disposed in said housing of each of said knife holders;
a respective knife head for each raising and lowering mechanism, wherein said knife head is carried by said raising and lowering mechanism and supports an upper knife in the form of a circular knife, further wherein said raising and lowering mechanism includes a piston having a piston rod for said knife head, and wherein a path of movement of said circular knife into a cutting position is delimited by an abutment;
a depth adjuster for fixing a cutting position of said circular knife when a knife head is lowered;
a setting instrument for indicating a position of cutting edges of one of said circular knives relative to one of said lower knives with reference to the true diameter of a new circular knife, wherein said depth adjuster is adapted to be positioned in conformity with a position value determined by said setting instrument;
a sensor aligned with an outer periphery of said circular knife; and
an adjusting mechanism, wherein during an alignment of said sensor with said cutting edges of said circular knife, which alignment is effected by positioning of said depth adjuster and/or displacement of said sensor, said adjusting mechanism, for a movement of said circular knife into its cutting position, is fixed.

2. A longitudinal slitting machine according to claim 1, wherein said setting instrument is embodied as a setting slide that is associated with said knife head in a raised rest position of said knife head and that is extendable until it rests against said lower knife, and wherein an indicator means is provided that is adapted to make visible an extension path of said setting slide that covers the distance of the cutting edge of a new circular knife from said lower knife.

3. A longitudinal slitting machine according to claim 2, wherein said setting slide is a component of a setting tool that during a set-up of said longitudinal slitting machine is adapted to be mounted on said knife head of each knife holder supported on said crosspiece.

4. A longitudinal slitting machine according to claim 2, wherein a respective setting slide is disposed on each of said knife holders supported on said crosspiece.

5. A longitudinal slitting machine according to claim 2, wherein said setting slide is a slide that is longitudinally movable relative to said knife head or is embodied as a slide that is adapted to be swung out relative to said knife head or is embodied as a slide that is rotateable about an axis of said knife.

6. A longitudinal slitting machine according to claim 2, wherein said setting slide is provided with a measuring mark that is movable relative to a fixed scale.

7. A longitudinal slitting machine according to claim 2, wherein said extension path of said setting slide is adapted to be converted in a measuring device and is adapted to be made visible via a numerical indicator.

8. A longitudinal slitting machine according to claim 2, wherein in a starting position said setting slide is respectively adapted or conformed to the true diameter of a new circular knife.

9. A longitudinal slitting machine according to claim 8, wherein different setting slides are provided for an adaptation to different circular knives having different true diameters that are adapted to be used on said knife holder, and wherein said different setting slides are respectively adapted to be exchangeably fixed in position on said knife head.

10. A longitudinal slitting machine according to claim 2, wherein said setting slide is fixed on said knife head, and wherein scales are adapted to be provided on said setting slide for an adaptation to different circular knives that can be mounted on said knife holder and have different true diameters, wherein said scales are adapted to said true diameters.

11. A longitudinal slitting machine according to claim 10, 10 wherein the different scales are exchangeably disposed on said knife head.

12. A longitudinal slitting machine according to claim 10, wherein a scaling strip having different portions that contain the various scales is displaceably disposed on said knife head.

13. A longitudinal slitting machine according to claim 2, wherein said extension path of said setting slide is converted in a measuring device and is adapted to be made visible in a numerical indicator, and wherein different true diameters of new circular knives are stored in said measuring device and are adapted to be supplied as a function of the circular knife that is respectively to be used.

14. A longitudinal slitting machine according to claim 1, wherein a scale is associated with said depth adjuster for determining the position of said depth adjuster in conformity with the position value determined by said setting instrument.

15. A longitudinal slitting machine according to claim 1, wherein a measuring device is associated with said depth adjuster for indicating displacement of said depth adjuster in a numerical indicator.

16. A longitudinal slitting machine according to claim 1, wherein for the configuration of said depth adjuster, said housing of said knife holder, accompanied by interposition of an adjustment device, is supported on said crosspiece in such a way that said knife holder is adapted to be brought into various positions relative to said crosspiece, and wherein said sensor is disposed on said crosspiece.

17. A longitudinal slitting machine according to claim 1, wherein for the configuration of said depth adjuster, a cylinder of said raising and lowering mechanism for accommodating said piston having said piston rod is displaceably disposed in said housing of said knife holder, and wherein said sensor is disposed on said housing of said knife holder.

18. A longitudinal slitting machine according to claim 1, wherein for the configuration of said depth adjuster, said abutment is adjustably disposed for the movement of a counter abutment connected with said piston rod into the cutting position of said circular knife, and wherein said sensor is displaceable relative to said housing of said knife holder and is coupled with said adjustable abutment for said counter abutment in such a way that a displacement of said sensor brings about a displacement of said abutment with a displacement path for said abutment that corresponds to the displacement path of said sensor.

19. A longitudinal slitting machine according to claim 18, wherein said sensor is carried by a support rod.

20. A longitudinal slitting machine according to claim 19, wherein said support rod is displaceably disposed on said housing of said knife holder, and wherein said support rod is held by spring bias in abutment against said displaceable abutment or is fixedly connected with said displaceable abutment.

21. A longitudinal slitting machine according to claim 19, wherein said sensor is displaceable on said support rod and is adapted to be fixed in various positions thereon, or wherein said support rod is embodied as a telescopic rod.

22. A longitudinal slitting machine according to claim 1, wherein said setting instrument is embodied as a setting tool that is adapted to be mounted on each of said knife heads of said knife holders that are supported on said crosspiece, further wherein said setting tool is provided with a dimension that corresponds to the true diameter of a new circular knife, and wherein said setting tool, together with said knife head, is adapted to be brought into the lowered cutting position of said circular knife.

23. A longitudinal slitting machine according to claim 22, wherein a displacement path between the raised rest position of said knife head, and the position of said setting tool when moved into an abutment position upon said lower knife, is adapted to be made visible by means of an indicator means.

24. A longitudinal slitting machine according to claim 22, wherein on a side facing said lower knife said setting tool has a step that is provided with a first leg that rests upon a cutting edge of said lower knife, and is provided with a second leg that extends beyond said cutting edge of said lower knife with a prescribed overlap depth, and wherein the distance between the end of said second leg that forms said overlap depth and an upper edge of said setting tool corresponds to the diameter of a circular knife used as said upper knife.

25. A longitudinal slitting machine according to claim 24, wherein said second leg of said setting tool that forms said overlap depth has a material thickness suitable for adjusting setting of a lateral adjustment path of said upper knife relative to said lower knife.

26. A longitudinal slitting machine according to claim 24, wherein said lower knife is embodied as a grooved knife, and wherein said second leg of said setting tool that forms said overlap depth respectively extends into grooves that form said cutting edge of said lower knife.
